(19) United States
(12) Patent Application Publication
(10) Pub. No.: US 2011/0279106 A1
(43) Pub. Date: Nov. 17, 2011

(54) Threshold voltage generating circuit

(75) Inventor: Fangping Fan, Chengdu (CN)

(73) Assignee: IPGoal Microelectronics (SiChuan) Co., Ltd.

(21) Appl. No.: 13/105,855

(22) Filed: May 11, 2011

(30) Foreign Application Priority Data
May 12, 2010 (CN) 201010170364.6

(51) Int. Cl. G05F 3/24

(52) U.S. Cl. 323/313

(57) ABSTRACT

A threshold voltage generating circuit includes a main control circuit and a biasing circuit connected with the main control circuit. The main control circuit includes a first switching element, a second switching element connected with the first switching element, a third switching element connected with the second switching element, and a first operational amplifier connected with the third switching element, wherein an output end of the first operational amplifier outputs a threshold voltage. The threshold voltage generating circuit can generate the more precise threshold voltage.

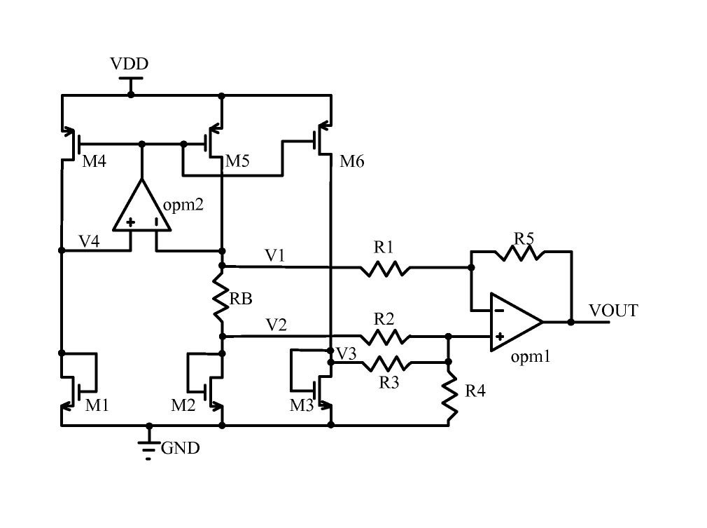

### BACKGROUND OF THE PRESENT INVENTION

1. Field of Invention

The present invention relates to a voltage generating circuit, and more particularly to a threshold voltage generating circuit which is capable of generating the threshold voltage.

2. Description of Related Arts

The threshold voltage is usually defined as the input voltage of the end point of the transition region where the output voltage sharply varies with the input voltage in the transmission characteristic curve. In generally, the threshold voltage varies with technology and temperature. In the prior art, the threshold voltage is often obtained by finding the database and seldom obtained by a circuit which is capable of directly generating the more precise threshold voltage.

### SUMMARY OF THE PRESENT INVENTION

An object of the present invention is to provide a threshold voltage generating circuit which is capable of directly generating the more precise threshold voltage.

Accordingly, in order to accomplish the above object, the present invention provides a threshold voltage generating circuit, comprising:

a main control circuit comprising a first switching element, a second switching element connected with the first switching element, a third switching element connected with the second switching element, and a first operational amplifier connected with the third switching element, wherein an output end of the first operational amplifier outputs a threshold voltage; and

a biasing circuit connected with the main control circuit.

Compared with the prior art, the threshold voltage generating circuit of the present invention is capable of generating the more precise threshold voltage based on the change of technology and temperature.

These and other objectives, features, and advantages of the present invention will become apparent from the following detailed description, the accompanying drawings, and the appended claims.

### BRIEF DESCRIPTION OF THE DRAWINGS

The drawing is a circuit diagram of a threshold voltage generating circuit according to a preferred embodiment of the present invention.

### DETAILED DESCRIPTION OF THE PREFERRED EMBODIMENT

Referring to the drawing, a threshold voltage generating circuit according to a preferred embodiment of the present invention is illustrated, wherein the threshold voltage generating circuit comprises a main control circuit and a biasing circuit connected with the main control circuit.

The main control circuit comprises a first switching element, a second switching element, a third switching element, a first resistor R1, a second resistor R2, a third resistor R3, a fourth resistor R4, a fifth resistor R5 and a first operational amplifier omp1. The biasing circuit comprises a fourth switching element, a fifth switching element, a sixth switching element, a sixth resistor RB and a second operational amplifier omp2.

In the preferred embodiment of the present invention, the first switching element is a first field effect transistor (FET) M1, the second switching element is a second field effect transistor (FET) M2, the third switching element is a third field effect transistor (FET) M3, the fourth switching element is a fourth field effect transistor (FET) M4, the fifth switching element is a fifth field effect transistor (FET) M5, and the sixth switching element is a sixth field effect transistor (FET) M6. The first FET M1, the second FET M2 and the third FET M3 are N-type FETs (NMOS). The fourth FET M4, the fifth FET M5 and the sixth FET M6 are P-type FETs (PMOS). In other preferred embodiments, the FETs can be replaced by other switching components or circuits which are capable of achieving the same function as required.

The specific connection relations of the threshold voltage generating circuit are described as follows. The grid electrode of the first FET M1 is connected with the drain electrode thereof, the drain electrode of the first FET M1 is connected with the positive-going input end of the second operational amplifier omp2, the source electrode of the first FET M1 is connected with the source electrode of the second FET M2, the grid electrode of the second FET M2 is connected with the drain electrode thereof, the grid electrode of the third FET M3 is connected with the drain electrode thereof, the source electrode of the third FET M3 is connected with the source electrode of the second FET M2, the drain electrode of the third FET M3 is connected with the positive-going input end of the first operational amplifier omp1 through the third resistor R3, the source electrode of the third FET M3 is connected with the positive-going input end of the first operational amplifier ompl through the fourth resistor R4, the positive-going input end of the first operational amplifier omp1 is connected with the reversed input end of the second operational amplifier omp2 through the second resistor R2 and the sixth resistor RB, the reversed input end of the first operational amplifier omp1 is connected with the reversed input end of the second operational amplifier omp2 through the first resistor R1, the reversed input end of the first operational amplifier omp1 is connected with the output end VOUT of the first operational amplifier omp1 through the fifth resistor R5. The grid electrode of the fourth FET M4 is connected with the grid electrode of the fifth FET M5, the drain electrode of the fourth FET M4 is connected with the positive-going input end of the second operational amplifier omp2, the source electrode of the fourth FET M4 is connected with the source electrode of the fifth FET M5, the grid electrode of the fifth FET M5 is connected with the output end of the second operational amplifier omp2, the drain electrode of the fifth FET M5 is connected with the reversed input end of the second operational amplifier omp2, the grid electrode of the sixth FET M6 is connected with the grid electrode of the fifth FET M5, the source electrode of the sixth FET M6 is connected with the source electrode of the fifth FET M5, the drain electrode of the sixth FET M6 is connected with the drain electrode of the third FET M3. The source electrode of the first FET M1, the source electrode of the second FET M2 and the source electrode of the third FET M3 are connected with the ground GND. The source electrode of the fourth FET M4, the source electrode of the fifth FET M5 and the source electrode of the sixth FET M6 are connected with the power supply VDD. The drain electrode of the second FET M2 is connected with the reversed input end of the second operational amplifier opm2 through the sixth resistor RB. The drain electrode of the second FET M2 is connected with the positive-going input end of the first operational amplifier opm1 through the second resistor R2.

The threshold voltage generating circuit can generate a more precise threshold voltage based on the change of technology and temperature, which is detailedly described as follows.

V1=V4=VTH+sqrt(I1*K1),

V2=VTH+sqrt(I2*K2),

V3=VTH+sqrt(I3*K3),
wherein, K1=2/(μnCox(W/L)1),
K2=2/(μnCox(W/L)2),
K3=2/(μnCox(W/L)3).

Here, VTH denotes the threshold voltage of NMOS, I1 denotes the current passing through the first FET M1, I2 denotes the current passing through the second FET M2, I3 denotes the current passing through the third FET M3, μn denotes the electron mobility, Cox denotes the gate oxide capacitance per unit area, (W/L)1 denotes the width to length ratio of the first FET M1, (W/L)2 denotes the width to length ratio of the second FET M2, (W/L)3 denotes the width to length ratio of the third FET M3.

VOUT=V2+V3−V1=VTH+sqrt(I3*K3)+sqrt(I2*K2)·sqrt(I1*K1),

If I1=I2=I3=I,

VOUT=VTH+sqrt(I)*(sqrt(K3)+sqrt(K2)−sqrt(K1)).

By selecting the width to length ratios of M1, M2 and M3, the expression of sqrt(K3)+sqrt(K2)−sqrt(K1) can be equal to zero. Accordingly, VOUT is equal to VTH.

Furthermore, VOUT=VTH can be achieved by maintaining the same width to length ratios of M1, M2 and M3 and adjusting the value of I1:I2:I3, namely, adjusting the width to length ratios of M4, M5 and M6. Also, VOUT=VTH can be achieved by simultaneously adjusting the value of I1:I2:I3 and the width to length ratios of M4, M5 and M6.

The threshold voltage generating circuit can generate the more precise threshold voltage based on the change of technology and temperature.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A threshold voltage generating circuit, comprising:
a main control circuit comprising a first switching element, a second switching element connected with said first switching element, a third switching element connected with said second switching element, and a first operational amplifier connected with said third switching element, wherein an output end of said first operational amplifier outputs a threshold voltage; and
a biasing circuit connected with said main control circuit.

2. The threshold voltage generating circuit, as recited in claim 1, wherein said first switching element is a first field effect transistor, said second switching element is a second field effect transistor, and said third switching element is a third field effect transistor.

3. The threshold voltage generating circuit, as recited in claim 2, wherein a grid electrode of said first field effect transistor is connected with a drain electrode thereof, a grid electrode of said second field effect transistor is connected with a drain electrode thereof, a grid electrode of said third field effect transistor is connected with a drain electrode thereof, and a source electrode of said first field effect transistor, a source electrode of said second field effect transistor and a source electrode of said third field effect transistor are connected with ground.

4. The threshold voltage generating circuit, as recited in claim 3, wherein said main control circuit further comprises a third resistor, a fourth resistor and a fifth resistor, wherein said drain electrode of said third field effect transistor is connected with a positive-going input end of said first operational amplifier through said third resistor, said source electrode of said third field effect transistor is connected with said positive-going input end of said first operational amplifier through said fourth resistor, and a reversed input end of said first operational amplifier is connected with an output end thereof through said fifth resistor.

5. The threshold voltage generating circuit, as recited in claim 1, wherein said biasing circuit comprises a fourth switching element connected with said first switching element, a fifth switching element connected with said fourth switching element, a sixth switching element connected with said fifth switching element, and a second operational amplifier connected with said fourth and fifth switching elements.

6. The threshold voltage generating circuit, as recited in claim 5, wherein said main control circuit further comprises a first resistor and a second resistor, and said biasing circuit further comprises a sixth resistor, wherein a positive-going input end of said first operational amplifier is connected with a reversed input end of said second operational amplifier through said second resistor and said sixth resistor, a reversed input end of said first operational amplifier is connected with said reversed input end of said second operational amplifier through said first resistor, a positive-going input end of said second operational amplifier is connected with said first switching element.

7. The threshold voltage generating circuit, as recited in claim 6, wherein said fourth switching element is a fourth field effect transistor, said fifth switching element is a fifth field effect transistor, and said six switching element is a six field effect transistor.

8. The threshold voltage generating circuit, as recited in claim 7, wherein a grid electrode of said fourth field effect transistor, a grid electrode of said fifth field effect transistor and a grid electrode of said six field effect transistor are connected with an output end of said second operational amplifier, a drain electrode of said fourth field effect transistor is connected with said positive-going input end of said second operational amplifier, a drain electrode of said fifth field effect transistor is connected with said reversed input end of said second operational amplifier, a source electrode of said fourth field effect transistor, a source electrode of said fifth field effect transistor and a source electrode of said sixth field effect transistor are connected with a power supply.

9. The threshold voltage generating circuit, as recited in claim 2, wherein said first, second and third field effect transistors are NMOS transistors.

10. The threshold voltage generating circuit, as recited in claim 3, wherein said first, second and third field effect transistors are NMOS transistors.

11. The threshold voltage generating circuit, as recited in claim 4, wherein said first, second and third field effect transistors are NMOS transistors.

12. The threshold voltage generating circuit, as recited in claim 7, wherein said fourth, fifth and six field effect transistors are PMOS transistors.

13. The threshold voltage generating circuit, as recited in claim 8, wherein said fourth, fifth and six field effect transistors are PMOS transistors.

14. A threshold voltage generating circuit, comprising:
a main control circuit comprising a first field effect transistor, a second field effect transistor, a third field effect transistor, a first resistor, a second resistor, a third resistor, a fourth resistor, a fifth resistor and a first operational amplifier; and
a biasing circuit comprising a fourth field effect transistor, a fifth field effect transistor, a sixth field effect transistor, a sixth resistor and a second operational amplifier,
wherein a drain electrode of said first field effect transistor is connected with a grid electrode thereof, a drain electrode of said second field effect transistor is connected with a grid electrode thereof, a drain electrode of said third field effect transistor is connected with a grid electrode thereof, said drain electrode of said second field effect transistor is connected with a positive-going input end of said first operational amplifier through said second resistor, said drain electrode of said third field effect transistor is connected with said positive-going input end of said first operational amplifier through said third resistor, said source electrode of said third field effect transistor is connected with said positive-going input end of said first operational amplifier through said fourth resistor, a reversed input end of said first operational amplifier is connected with an output end thereof through said fifth resistor,
wherein a grid electrode of said fourth field effect transistor, a grid electrode of said fifth field effect transistor, a grid electrode of said sixth field effect transistor are connected with an output end of said second operational amplifier, a drain electrode of said fourth field effect transistor is connected with a positive-going input end of said second operational amplifier and said drain electrode of said first field effect transistor, a drain electrode of said fifth field effect transistor is connected with a reversed input end of said second operational amplifier, said drain electrode of said fifth field effect transistor is connected with said drain electrode of said second field effect transistor through said sixth resistor, said drain electrode of said sixth field effect transistor is connected with said drain electrode of said third field effect transistor, said reversed input end of said first operational amplifier is connected with said reversed input end of said second operational amplifier through said first resistor, said positive-going input end of said first operational amplifier is connected with said reversed input end of said second operational amplifier through said second and sixth resistors,
wherein a source electrode of said first field effect transistor, a source electrode of said second field effect transistor and a source electrode of said third field effect transistor are connected with ground,
wherein a source electrode of said fourth field effect transistor, a source electrode of said fifth field effect transistor and a source electrode of said sixth field effect transistor are connected with a power supply,
wherein said output end of said first operational amplifier outputs a threshold voltage.

15. The threshold voltage generating circuit, as recited in claim 14, wherein said first, second and third field effect transistors are NMOS transistors, wherein said fourth, fifth and six field effect transistors are PMOS transistors.
